(19) United States
(12) Patent Application Publication
(10) Pub. No.: US 2024/0070410 A1
(43) Pub. Date: Feb. 29, 2024

(54) DETERMINING COLLECTIVE LOCATION OF LOW ENERGY WIRELESS TAGS

(71) Applicant: Wiliot, Ltd., Caesarea (IL)

(72) Inventors: Ido ZELMAN, Hod Hasharon (IL); Tsvika RABKIN, Pardes Hanna-Karkur (IL); Amnon WAHLE, Tel-Aviv (IL); Ohad SILBERT, Ra'anana (IL); Yitzhak PELEG, Netanya (IL); Keren GRUTEKE, Haifa (IL); Thaddeus SEGURA, San-Francisco, CA (US)

(73) Assignee: Wiliot, Ltd., Caesarea (IL)

(21) Appl. No.: 17/823,358

(22) Filed: Aug. 30, 2022

(51) Int. Cl. G06K 7/10; G06K 19/07

(52) U.S. Cl. CPC G06K 7/10366; G06K 19/0723

(57) ABSTRACT

A method and system for determining locations of internet of things (IoT) tags are provided. The method includes receiving, during a predefined time window, packets from a plurality of gateways, wherein a received packets include at least sensing signals transmitted from the IoT tags; determining an affinity among the IoT tags based on the sensing signals; determining locations of IoT tags based on the determined affinity and the sensing signals, wherein a location of an IoT tag is a probability that an IoT tag is located in proximity to a gateway; and reporting the determined locations to a user terminal.

### TECHNICAL FIELD

The present disclosure generally relates to internet of things (IoT) tags, including low-energy sensing tags, and more particularly, for determining the affinity and collective location of such tags.

### BACKGROUND

Determining and monitoring locations of products are important to determine, for example, an inventory level, misplacement of items, theft detection, and so on. The products or items are typically placed on shelves and/or containers, but once placed, there are no efficient solutions to detect the current location. This problem is related to many industries including, but not limited to, retail, manufacturing, medical, and so on.

Current solutions for monitoring current locations of items, specifically small-size objects, typically require manual labor or complex infrastructure. For example, one solution would require a person to physically identify the locations of all items. This would require expensive labor and may result in human error. An automated solution includes cameras or other tracking devices. However, such a solution would require line of sight between the items and the camera(s) and are cumbersome to install and maintain. Further, the tracking cameras are ineffective when the items are moved from one location to another where there is no coverage of a tracking camera. The processing of images requires complex algorithms and extensive computing resources.

Other solutions suggest tracking the locations of items using radio-frequency identification (RFID) where an RFID tag is placed on each item. An RFID tag includes a tiny radio transponder, a radio receiver and a transmitter. When triggered by an electromagnetic interrogation pulse from a nearby RFID reader device, the tag transmits digital data, usually an identifying inventory number, back to the reader. This number can be used to track inventory goods. However, when the tag does not transmit a signal or such signal is not received, there is no way to determine the location of the RFID tag, thus the location of the item attached to the tag cannot be determined.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for determining locations of internet of things (IoT) tags. The method includes receiving, during a predefined time window, packets from a plurality of gateways, wherein a received packet includes at least sensing signals transmitted from the IoT tags; determining an affinity among the IoT tags based on the sensing signals; determining locations of IoT tags based on the determined affinity and the sensing signals, wherein a location of an IoT tag is a probability that an IoT tag is located in proximity to a gateway; and reporting the determined locations to a user terminal.

Certain embodiments disclosed herein include a system for determining locations of internet of things (IoT) tags includes a processing circuitry; a memory connected to the processing circuitry and configured to contain a plurality of instructions that when executed by the processing circuitry configure the system to: receive, during a predefined time window, packets from a plurality of gateways, wherein a received packet includes at least sensing signals transmitted from the IoT tags; determine an affinity among the IoT tags based on the sensing signals; determine locations of IoT tags based on the determined affinity and the sensing signals, wherein a location of an IoT tag is a probability that an IoT tag is located in proximity to a gateway; and report the determined locations to a user terminal.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a low-energy communication system illustrating the various embodiments.

FIG. 2 is a schematic diagram demonstrating a journey of items monitored according to the disclosed embodiments.

FIG. 3 is a flowchart of a method for determining affinities between IoT tags according to an embodiment.

FIG. 4 is an example graph for solving the probabilistic graphical model for determining the collective behavior of IoT tags.

FIG. 5 is a graph showing the tracking of collective locations of a group of IoT tags according to an example embodiment.

FIG. 6 is a schematic diagram of a gateway used for detecting items using low energy sensing, according to an embodiment.

FIG. 7 is a schematic diagram of a wireless IoT tag utilized according to the disclosed embodiments.

FIG. 8 is a schematic diagram of a server according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

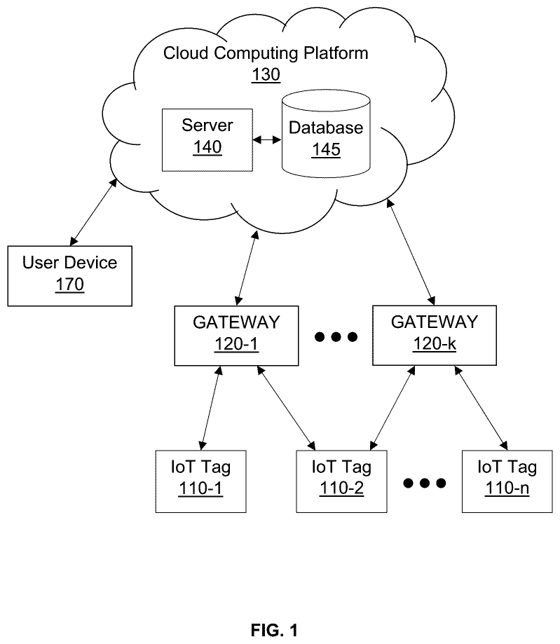

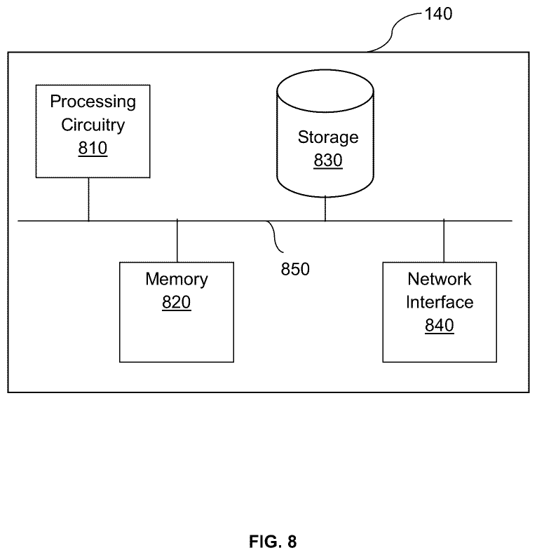

FIG. 1 is an example schematic diagram of a low-energy communication system 100 utilized to describe the various embodiments. The system 100 includes a plurality of wireless Internet of Things (IoT) tags 110-1 through 110-n (collectively referred to as an IoT tag 110 or IoT tags 110), a plurality of gateways 120-1 through 120-k (collectively referred to as a gateway 120 or gateways 120), and a cloud computing platform 130. The system 100 also includes at least one server 140 that may be deployed in the cloud computing platform 130. The server 140 may be realized as a physical machine, a virtual machine, or a combination thereof. An example block diagram of the server 140 is provided in FIG. 8. The cloud computing platform 130 may be a public cloud, a private cloud, a hybrid cloud, or a combination thereof. A database 145 may be deployed in the cloud computing platform 130 and may be connected to the server 140. The database 145 may store events generated by server 140, identifiers (IDs) of IoT tags 110, and other signals.

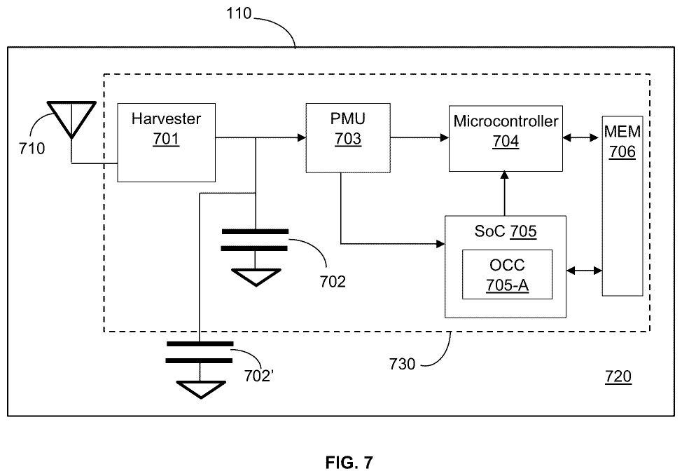

In an embodiment, the IoT tag 110 is a battery-free IoT tag as discussed in FIG. 7. Also, communication among each IoT tag 110 and the gateway 120 may be performed using a low-energy communication protocol. The communication between the cloud computing platform 130 and the gateway 120 is over, for example, the Internet. An IoT tag 110 may include a printed battery.

In an example embodiment, the low-energy communication protocol includes a Bluetooth Low Energy (BLE) protocol, which are short-wavelength radio waves operating at a range of about 2.40 to 2.485 MHz, and commonly used among portable wireless devices. The cloud computing platform 130 may include a public cloud, a private cloud, a hybrid cloud, or combination thereof.

In the example embodiment, the IoT tags 110 are placed on a surface, which may include a cart, a shelf, a box, a container, and the like. An IoT tag 110 may be glued, attached, or fastened to an item. For example, the form factor of an IoT tag 110 may be a sticker that can be applied to an item. The number of IoT tags 110 on the item depends on, for example, but not limited to, a size, type, shape, and the like, and any combination thereof, of the item. The items can be any type of product or object ranging from groceries to fashion items. For example, the IoT tag 110 is attached to shoe boxes in a warehouse. In another example, the IoT tag 110 is attached to a box of tomatoes being delivered and displayed at the storefront.

The arrangement shown in FIG. 1 also includes a user device 170 on which alerts, reports, and so on can be presented to the user. For example, an indication of the location of each item can be displayed. The connection between the user device 170 and the server 140 is over the Internet. In other configurations, the notifications (such as the reports and alerts) are reported on the display on the gateway 120, when the gateway 120 includes a display. The user device 170 may include, for example, a personal computer (PC), a smartphone, a laptop, a user terminal, and the like.

According to the disclosed embodiments, a location of each item is determined based on signals received from a group of IoT tags 110 and a collective behavior analysis of such signals. The analysis of signals is performed for during temporal time windows. The group of IoT tags 110 includes co-located IoT tags that exhibit strong affinity to each other. It should be noted that the collective location determined through collective behavior analysis enables accurate determination of IoT tag locations, improved from location determination using individual IoT tags.

The collective location of a specific group of IoT tags 110 is determined for consecutive temporal time windows to track the movements of items affixed with the respective IoT tags 110. The temporal time window is a time period that may be, for example and not limited to, a predefined time period, defined by number of data packets, and the like. In a further embodiment, the collective locations of the group of IoT tags 110 may be directly transferred to identify locations of co-located individual IoT tags 110 of the specific group of IoT tags 110. In an embodiment, the determined locations for the IoT tags 110 at a time window are reported back from the server 140 to the gateway 120, which in return may be displayed on the user device 170. The server 140 is further configured to generate a set of insights, discussed below. Such insights are also reported to the gateway 120, which in return may be displayed on the user device 170.

In an embodiment, the server 140 is configured to analyze sensing signals as transmitted by the IoT tags 110. To this end, each gateway 120 is configured to receive sensing signals from the IoT tags 110, encapsulate the received signals together with additional data in data packets, and transmit the data packets to the cloud computing platform 130 to be processed by the server 140. A gateway 120 communicates with the IoT tags 110 over low-energy communication protocol (e.g., BLE), and with the cloud computing platform 130 may be, for example, over the Internet. The server 140 may be deployed on-premises, and in such embodiments, the gateway 120 may communicate with the server 140 over the network.

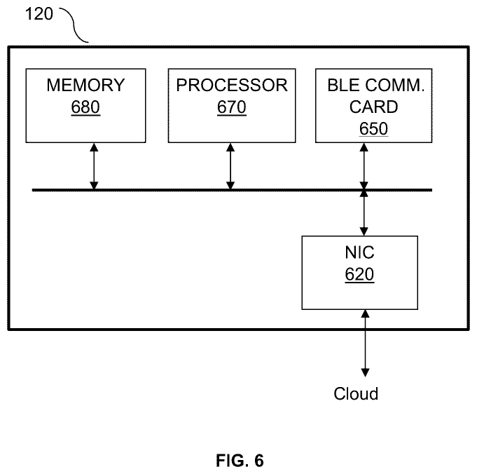

A gateway 120 may include any edge computing device, such as a laptop, a smartphone, a PC, and the like. In an embodiment, a gateway 120 may be installed with an agent or application (not shown in FIG. 1) in a standard computing device (such as a PC, a laptop, a tablet computer, a smartphone, and the like). The agent, when executed, is configured to control the communication between the IoT tag 110 and the server 140. In certain configurations, a gateway 120 may include an IoT tag 110 that is powered by a battery (or other power sources). An example implementation of a gateway 120 is discussed with reference to FIG. 6.

In an embodiment, an IoT tag 110 senses a particular radio frequency (RF) activity caused by an interference to the ambient RF field, which results in a change in a calibration frequency of the IoT tag 110, and such a change is translated into a sensing signal. The sensing signal may include a frequency word, a received signal strength indicator (RSSI), a digitally controlled oscillator (DCO) signal, and the like, or any combination thereof.

A RSSI is a measurement of the power present in a received radio signal. For example, the RSSI value of an IoT tag (e.g., 110-1) received at least one gateway (e.g., 120-1) changes as the item with the IoT tag 110-1 is moved to a different position, for example, away from the one gateway (e.g., 120-1).

A frequency word is measured by an IoT tag 110 depending on a frequency calibration of the IoT tag 110. In an embodiment, changes to the surrounding environment of an IoT tag 110, such as, but not limited to, the number of items, random objects, proximity to gateways or other objects, and temperature, change the value detected by the IoT tag 110 from synchronization, thereby changing the value of the frequency word. A value of frequency words can be measured as dBC/Hz, where the dBC unit is decibels relative to the carrier. In an example embodiment, the frequency calibration is discussed in more detail with reference to FIG. 7.

A DCO signal is a control signal of the internal capacitor that is used to calibrate the internal capacitor and changes its capacitance value to counteract the capacitance that a new material imposes. That is, the IoT tag 110 senses whether the transmission frequency is corrected and, if not, the DCO is adjusted to the main frequency of the transmission. When the surrounding proximate to a tag is modified, the tag recalibrates itself to the same transmission frequency by changing the capacitance value of its internal capacitor. In an embodiment, the transmission frequency may be one of the channels of the BLE transmission protocol. It should be noted that other low-energy communication protocols are also applicable.

As explained in more detail below, an IoT tag 110 is configured to send sensing signals, and other information to a gateway 120. It should be further noted that signals transmitted by the IoT tag may be received at multiple gateways 120. A gateway 120 is further configured to relay the combined information received from the IoT tag 110 to the server 140. The server 140 is configured to perform further processing to determine affinity and perform the collective behavior analysis of IoT tags 110.

In an embodiment, a data packet transmitted by each gateway 120 to the server 140 includes, without limitation, a sensing signal, an identifier (ID) of an IoT tag 110, and an identifier (ID) of the gateway 120. In an embodiment, the ID of the IoT tag 110 is a unique identifier (ID) that is set during the production of the IoT tag 110. The signals sent by the IoT tag 110 are received at a gateway 120, which, in turn, is configured to periodically send the data packets to the server 140.

In an embodiment, the IoT tags 110 transmit signals intermittently rather than continuously with periods of silence. Such intermittent transmission of signals is implemented to conserve energy at the IoT tags 110, which may be, but is not limited to, battery-less IoT tags. In a further embodiment, the ID of the gateway 120 is a unique identifier (ID) identifying the gateway 120 from which the data packets are relayed to the server 140. The gateways 120 are distributed at different positions/locations, and thus, the reception of sensing signals from the same IoT tag 110 can differ depending on the location of a gateway 120. That is, some gateway 120 may receive the signals, and some not.

The server 140 is configured to process the data packets received by one or more gateways 120 to determine the location of the IoT tags 110. In another embodiment, the server 140 may be configured to determine the location of each group of IoT tags 110 (i.e., items with such IoT tags attached) based on collective behavior analysis. The collective behavior allows for output group-based location of the IoT tags 110. In an embodiment, the collective behavior analysis is based on processing the sensing signals transmitted by the IoT tags 110. In an embodiment, other information derived based on the sensing signals, such as temperature in the area of the tag, a motion indication, and the like can be processed and utilized. In an embodiment, the sensing signals transmitted by the IoT tags 110 are relayed to the server 140 by one or more gateways 120 and thus, gateway IDs are included in the packets sent to the server 140. As noted above, the gateways 120 are positioned at separate locations within a space, a warehouse, a store, and more. In an embodiment, the group of IoT tags 110 for collective behavior analysis is determined based on the affinity between individual IoT tags 110. In an embodiment, as will be discussed below, the collective behavior, and specifically the location of IoT tags with respect to the gateway, is determined using a probabilistic graphical mode, such as a dynamic Bayesian network (DBN).

To this end, the server 140 is first configured to aggregate packets from the gateways 120 received during predefined temporal time windows (for example, each window can be 5 minutes). Packets from multiple gateways 120 may be simultaneously received within the same time window. At the end of each time window, the received packets are processed, and at least the sensing signals included therein, together with the respective gateway IDs are added to a vector created for each IoT tag ID.

It should be noted that the external parameters can be added as additional rows to create an N-dimensional vector (where N is an integer equal or great than one) for each IoT tag 110, including N sensing signals which may be transmitted from the IoT tags or derived from such signals. Example for such signals include a frequency word, a transmission rate, a temperature, a motion indication, and the like. In an embodiment, the vector may include null values when no sensing signal is received from at least one gateway 120. It should be further noted that the contents of the vector are updated at the end of each time window, during which the packets are received. In an embodiment, a statistical function is applied to the received sensing signals from each tag. Such statistical functions may include an average value, a maximum value, a minimum value, and the like.

For the sake of simplicity of the discussion, the disclosed embodiments will be discussed with reference to a vector, including a single sensing signal in the packet received from respective gateways 120. The sensing signal in an example embodiment is an RSSI value. However, the sensing signal may also include a frequency word, a transmission rate, a temperature, a motion indication, or any other feature extracted or derived from the sensing signals.

In an embodiment, the server 140 is configured to determine, for each IoT tag, an average sensing vector of based on the sensing signals received during each time window. An example average sensing vector when the sensing signal is an average RSSI value of all RSSI values received during a time window for a single tag, tag₁, is shown below. In this example, where ‘k’ indicates the gateway ID and is an integer equal or greater than one.

tag₁=(RSSI_{GW}_{₁},RSSI_{GW}_{₂}, . . . ,RSSI_{GW}_{ₖ})

The example average sensing vector, tag₁, above, presents average RSSI values transmitted by the IoT tag (e.g., IoT tag₁) and received by each gateway (e.g., gateway 120-1 though gateway 120-k) within a time window. For example, RSSI_GW₁ is the average of RSSI values received by a gateway (e.g., 120-1) during a time window. Similarly, the average sensing vectors are determined for ‘n’ number of IoT tags 110 that are available.

Based on an average sensing vector determined for each IoT tag, a sensing signal matrix (S) for the current time window (t) is output. The size of the matrix S is ‘n’ by ‘k’, where ‘n’ is the number of tags and ‘k’ is the number of gateways. The contents of the values are based on the respective average sensing vectors. For example, the matrix Sₜ for RSSI value is shown in Table 1. The value ‘0’ represents that RSSI values are collected from the respective IoT tags at the gateway. The sensing signal matrix S is updated at every time window. At t=0, the matrix S is initialized to ‘0’ values.

TABLE 1

| | GW₁ | GW₂ | GW₃ | . . . | GWₖ |
|---|---|---|---|---|---|
| tag₁ | RSSI_GW₁ | RSSI_GW₂ | RSSI_GW₃ | | RSSI_GWₖ |
| tag₂ | 0 | RSSI_GW₂ | 0 | | 0 |
| tag3 | 0 | 0 | 0 | | 0 |
| . . . | | | | | |
| . . . | | | | | |
| tagₙ | 0 | 0 | RSSI_GW₃ | | RSSI_GWₖ |

In a further embodiment, the server 140 is configured to determine and compute an affinity matrix (A) at each time window. The size of the affinity matrix is ‘n’ by ‘n’, where ‘n’ is the number of tags. Each cell in the matrix is a function of the affinity matrix at a previous time window and a distance metric between each pair of tags, where the diagonal includes ‘1’ (one) values. An example affinity matrix (A(t+1)) is shown in Table 2. The distance metric, du, between the IoT tag₁ and tag is determined between the average sensing vectors of the respective IoT tags. The affinity matrix (A) is updated at every time window and initialized to 0 values with 1 values along the diagonal. The affinity matrix (A) is a symmetric matrix.

TABLE 2

| | tag₁ | tag₂ | . . . | tag₃ |
|---|---|---|---|---|
| tag₁ | 1 | f(A(t), d₁₂) | | f(A(t), d₁ₙ) |
| tag₂ | f(A(t), d₂₁) | 1 | | f(A(t), d₂ₙ) |
| . . . | . . . | . . . | . . . | . . . |
| tag₃ | f(A(t), d₃₁) | f(A(t), d₃₂) | — | 1 |

The distance metric between two IoT tags, based on the sensing signal(s), can be computed over the respective average sensing vectors as a Euclidean distance metric or a cosine similarity, and the like. The functions for computing the Euclidean distance metric and cosine similarity are discussed in the related art. It should be noted that the distance metric is not the physical distance between the tags but rather a distance metric.

As an example, a basic Euclidean distance metric is:

dᵢⱼ=|R̅S̅S̅I̅ᵢ−R̅S̅S̅I̅ⱼ|

where R̅S̅S̅I̅ᵢ and R̅S̅S̅I̅ⱼ are the respective average RSSI values in the average sensing vectors included in the sensing matrix (S) for tag₁ and tag.

To determine the locations of the tags with respect to the gateways, the server 140 is configured to compute a location matrix (L) for each time window. The size of the matrix (L) is ‘n’ by ‘k’ where ‘n’ is the number of tags and ‘k’ is the number of gateways. The location matrix (L) at a current time window (t) provides the probability (pⱼᵣ) that a tag₁ (i=1, . . . , n) is located at the proximity of gateway (GWᵣ) (r=1, . . . , k). An example location matrix (L) is provided at Table 3.

TABLE 3

| | GW₁ | GW₂ | GW₃ | . . . | GWₖ |
|---|---|---|---|---|---|
| tag₁ | p₁₁ | p₁₂ | p₁₃ | | p₁ₖ |
| tag₂ | 0 | p₂₂ | p₂₃ | | 0 |
| tag3 | 0 | p₃₂ | p₃₂ | | 0 |
| . . . | | | | | |
| . . . | | | | | |
| tagₙ | 0 | 0 | pₙ₂ | | pₙₖ |

At t=0 the matrix (L₀) is set to with a probability distribution value (1/k, where ‘k’ is the number of gateways). The contents of the matrix is updated at each time window. The probability (pⱼᵣ) is a function of the current sensing signal (as indicated at the sensing signal matrix at time window t (Sₜ), the affinity matrix at the previous time window t₁ (Aₜ₋₁), and the location matrix at the previous time window t (Lₜ₋₁). That is, the values in the location matrix at the current time window t (Lₜ) is:

Lₜ=ƒ(Lₜ₋₁,Aₜ₋₁,Sₜ)

A probability value for each cell in the matrix Lₜ is inferred or computed by applying a Bayesian Inference model using the matrixes Aₜ₋₁ and Sₜ. The model can be represented as follows:

Pᵣ(Lₜ|Sₜ)=Pr(Sₜ|Lₜ)*Pr(Lₜ|Lₜ₋₁,Aₜ₋₁)*(Pr(Lₜ₋₁,Aₜ₋₁)

where Pr(Lₜ|Sₜ) is a function or model that infers the probabilities in Lₜ given the values in Sₜ and Pr(Lₜ|Lₜ₋₁, Aₜ₋₁) is a function or model that infers probabilities in Lₜ given the values in Lₜ₋₁ and Aₜ₋₁ and Pr(Lₜ₋₁,Aₜ₋₁) is a function or model that infers the probabilities of L and A at the previous time window.

In an embodiment, the server 140 is configured to cluster IoT tags 110 based on the location matrix at time t (Lₜ). The clustering provides a dynamic groping of all IoT tags proximity located at the same location. The clustering of IoT tags 110 may be performed using one more clustering algorithm discussed in the related art. Examples of such algorithms include, but are not limited to, hierarchical clustering or partitional clustering, where optimal clusters are based on silhouette score and the like.

In another embodiment, server 140 is further configured to determine anomalies in locations of tags (and hence items). That is, if a tag is determined to be outside of a cluster (low affinity to expected cluster/group), it would be considered as an anomaly and may be reported. The cause for such an anomaly may be determined if that item was misplaced or the tag is faulty. In an embodiment, an anomaly can be declared after observation of the anomaly in a few consecutive time windows.

It should be noted that the determination of a location of IoT tags and grouping of tags based on the affinity improves accuracy and eliminates noise and missing sensing signals that occur in individual IoT tags. For simplicity of explanation, a single sensing signal, RSSI, was selected to explain the process above. However, other sensing parameters and one or more sensing signals may be utilized.

As noted above, the IoT tags 110 are wireless sensing devices harvesting over-the-air energy. A change in the IoT tag 110 or its surroundings would trigger a change in its calibration frequency, and hence, in a frequency word transmitted by the IoT tag 110. It should be emphasized that an IoT tag 110 does not generate an explicit signal indicating a location of an IoT tag or changes in the IoT tag surroundings. The locations of the IoT tags are derived based on the changes in the values of the frequency words from transmitted sensing signals.

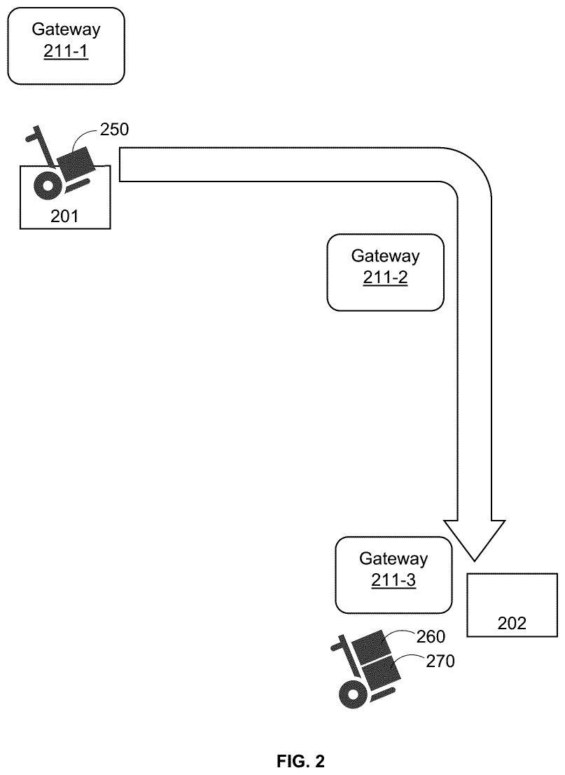

FIG. 2 is an example schematic diagram demonstrating a journey of items that are monitored according to the disclosed embodiments. In this example, groups of items 250, 260, and 270 (shown as boxes) are placed on a cart traveling in a warehouse where 3 gateways (GWs) 211-1, 211-2, and 211-3 are deployed. Each item of the group of items 250, items 260, and items 270 includes at least one IoT tag (not shown), such as the IoT tag 110 discussed above in FIG. 1.

The IoT tags on items 250, items 260, and items 270 all intermittently transmit sensing signals to the surrounding gateways (211-1 through 211-3), which relay preprocessed packets to the server (e.g., the server 140, FIG. 1). As noted above, such signals may include, for example, the RSSI values and do not include location-based information. In an embodiment, the surrounding gateways (211-1 through 211-3) may each receive different sensing signal values based on the location of the IoT tags on the items 250, 260, and 270. For illustrative purposes, FIG. 2 will be described with respect to one sensing signal, the RSSI.

The items 250 are initially placed at a location 201 in proximity to a gateway 211-1. At location 201, signals transmitted by the IoT tags of items 250 are received most strongly and consistently by gateway 211-1 due to the proximity. In the example illustration, the other gateways, gateway 211-2 and gateway 211-3, may or may not receive signals from the IoT tags on the items 250, and the signals received may be weaker than that received at gateway 211-1. The items 260 and items 270 are placed at a different location close to the gateway 211-3. Here, the sensing signals transmitted by IoT tags of items 260 and items 270 are most strongly received at gateway 211-3 compared to the gateways 211-1 or 211-2.

In an embodiment, a server (e.g., the server 140, FIG. 1) is configured to receive relayed data packets from the gateways (211-1 through 211-3) to determine the average RSSI values and, based on the average RSSI values, determine the affinity of the IoT tags, and their location for a current temporal time window. In the example illustrated herein, IoT tags of items 250 are clustered, and IoT tags of items 260 and items 270 may be clustered together.

It should be noted that neither the gateways (211-1 through 211-3) nor the server (e.g., the server 140, FIG. 1) receives location-based information, but rather the location of IoT tags is based on the processing of transmitted sensing signals from the IoT tags. In an event where a subset of items 250 is relocated to a different position in the following time window, a new affinity of such subset would be determined (through the computation of the affinity matrix), and their determined location would change.

In the example embodiment, the IoT tags of items 250 are grouped to determine a collective location of the items 250 that is close to the gateway 211-1. As the cart including items 250 is moved to a location 202, it passes through the gateway 211-2. Here, RSSI signals may be received, and relayed to the server (e.g., the server 140, FIG. 1) by all gateways. However, sensing signals would change (e.g., to be greater at 211-2) depending on the proximity of the current location of items 250 to the gateways. As the items 250 reaches the location 202, the sensing signals transmitted by the IoT tags on the items 250 may be greater at the gateway 211-3 due to its proximity to location 202.

It should be noted that the collective locations of the group of IoT tags are determined for each temporal time window and updated consecutively. As demonstrated in this example, the location of group of tags is based on affinity determined from sensing signals are collectively utilized for collective behavior analysis. The collective behavior analyses at each temporal time window enable location-based tracking and monitoring of the journey of the items (e.g., items 250). It should be appreciated that the collective behavior analysis enables improved accuracy in determining location of IoT tags by overcoming inaccuracies and disconnects that may occur from individual IoT tags, particularly due to their intermittent nature of transmitting sensing signals.

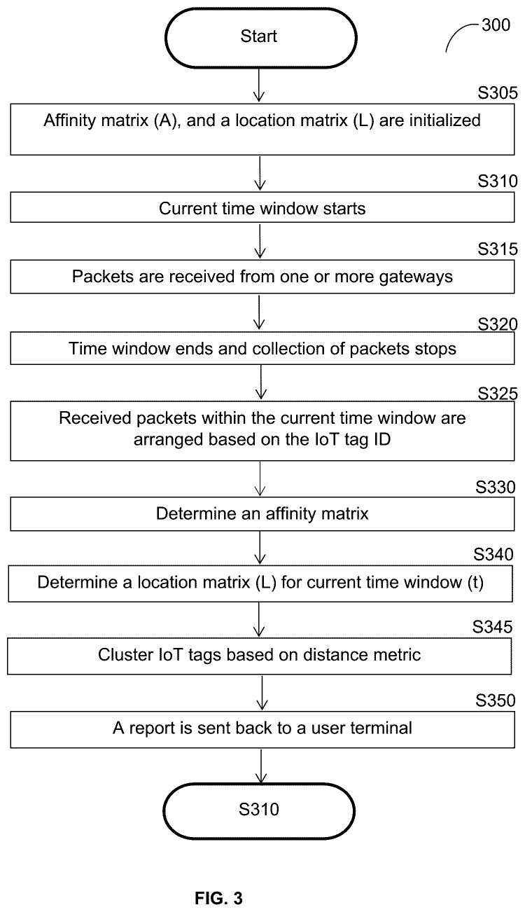

FIG. 3 is an example flowchart 300 illustrating a method for determining the location of IoT tags based on their collective behavior according to an embodiment. In an embodiment, the IoT tags (e.g., the IoT tags 110, FIG. 1) are attached to items, where each item may be associated with one or more tags. The method described herein may be performed by a server, such as the server 140 in FIG. 1. The following method will be discussed as an embodiment, where the collective behavior is determined using a dynamic Bayesian network (DBN).

At S305, an affinity matrix (A), and a location matrix (L) are initialized. The size of the affinity matrix is ‘n’ by ‘n’, where ‘n’ is the number of tags. Each cell in the affinity matrix (A) represents the distance metric between each pair of tags. The affinity matrix (A) is initialized to zeros where the diagonal includes ‘1’ (one) values. An example for the affinity matrix (A) is provided in Table 2. The location matrix holds the probability that each tag is in close proximity to a gateway. The size of the matrix (L) is ‘n’ by ‘k’, where ‘n’ is the number of tags and ‘k’ is the number of gateways. The matrix (L) may be initialized with a probability distribution value (1/k, where ‘k’ is the number of gateways).

At S310, a current time window starts. The during of such a time window is predefined.

At S315, packets are received from one or more gateways. Each packet includes at least one sensing signal sent by an IoT tag, an IoT tag ID, and a gateway ID. The sensing signals may include, but are not limited to, an RSSI value, a frequency word, a DCO value, a frequency calibration, and the like. The various types of signals are discussed in detail above. The IoT tag ID is a unique identifier of the IoT tag assigned to the tag during manufacture. The gateway ID is a unique identifier for the gateway that receives the sensing signals and relays such signals to the server. In an embodiment, the packets are preprocessed at the gateway prior to being sent to the server at the cloud computing platform (e.g., the cloud computing platform 130, FIG. 1). In a further embodiment, the packets may be stored at a database (e.g., the database 145, FIG. 1) at the cloud computing platform.

At S320, the time window ends, and the collection of the packet stops.

At S325, the received packets within the current time window are arranged based on the IoT tag ID. In an embodiment, the sensing signals received from one or more gateways are combined to create a vector for each IoT tag ID. That is, the vector for each IoT tag includes ‘sensing signal values received from ‘k’ (k is an integer value equal to or greater than 1) gateways. In an embodiment, a plurality of vectors may be created when more than one sensing signal is transmitted by the IoT tag within the time window.

In an embodiment, the sensing signals may be processed to determine sensing signals such as, but not limited to, a transmission rate, a temperature, a motion indication, and the like. In a further embodiment, the plurality of vectors may include vectors for each IoT tag within the time window created with respect to the sensing signal. In another embodiment, the received data packets are aggregated to create a matrix for each IoT tag, including the plurality of sensing signals occupying each row, with respect to the relayed gateway ID.

At S330, a sensing signal matrix (S) for the current time window is computed based on a collection of average sensing vectors of IoT tags. That is, a sensing signal matrix (S) includes the average sensing vectors as of each IoT tag as collected during the current time window. The size of the matrix S is ‘n’ by ‘k’, where n′ is the number of tags and ‘k’ is the number of gateways. An example of the sensing signal matrix (S) is shown in Table 1. An average sensing vector for each IoT tag is derived from the sensing signals received during the temporal time window. In an example embodiment, an average sensing vector of RSSI values for an IoT tag includes ‘k’ average RSSI values, where ‘k’ is a number of gateways. It should be noted that determining the average sensing vector is only one example and other statistical functions can be utilized on sensing signals derived from sensing signals of the time window.

At S340, the affinity matrix for the current time window is computed. To this end, first the distance metrics between each pair of IoT tags are computed based on the average sensing vectors in the sensing signal matrix (S) for the current time window. A distance metric closer to zero indicates that the IoT tags are very closely positioned to each other. As noted above, the distance metric between two pairs of IoT devices is determined as the Euclidean distance metric, cosine similarity, or similar methods. The computed distance metrics are saved can be saved in an auxiliary matrix. Then, the affinity matrix (A) for the current time window (t) is computed as a function of the distance metrics and the affinity matrix for the previous time window (t−1). As the time t=0, the affinity matrix (A) includes zero values. It should be noted that as two tags are close and share similar signals, the distance metric is closer to 0, and their affinity is closer to 1. When signals of such tags are different, the distance metric is closer to 1 and affinity is closer to 0.

At S345, the location matrix (L) for the current time window (t) is computed. The probabilities (pⱼᵣ) in the matrix (L) is a function of the current sensing signal (as indicated at the sensing signal matrix at time window t (Sₜ), the affinity matrix at the previous time window t−1 (Aₜ₋₁), and the location matrix at the previous time window t−1(Lₜ₋₁).

In an embodiment, the probabilities (pⱼᵣ) are inferred or computed using the Bayesian Inference model using the matrixes Aₜ₋₁, Sₜ. As provided above, the model can be represented as follows:

Pr(Lₜ|Sₜ)=Pr(Sₜ|Lₜ)*Pr(Lₜ|Lₜ₋₁,Aₜ₋₁)*Pr(Lₜ₋₁,Aₜ₋₁)

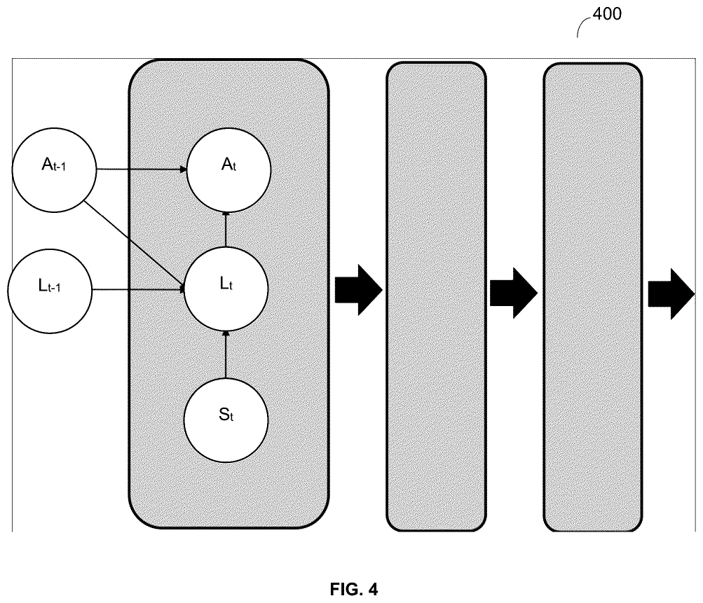

Solving this equation is based on a dynamic Bayesian network, a probabilistic graphical model representing a set of variables and their conditional dependencies via a directed acyclic graph. An example graph 400 representing the model of the above equation is provided in FIG. 4. The graph 400 shows the connections between the various matrixes described in greater detail above. It should be noted that the Bayesian model is only one example to solve the location matrix, and other probabilistic graphical models can be utilized for such purpose.

In an embodiment, the probabilities in the location matrix and the affinity matrix for the current time window can be further processed to provide additional insights with respect to the location of the tags. Such insights may include dynamic grouping of tags in proximity the same location, and anomaly, and routes (mapping).

The dynamic grouping of tags is performed by applying a clustering algorithm on the location matrix at the current time. The result of the process is a set of groups of IoT tags that are positioned proximity around the same location. Such groups may be adapted at every time window. Examples for clustering algorithms that can be used herein are provided above.

In another embodiment, the location matrix is processed to detect anomalies in locations of tags (and hence items). The cause for such an anomaly may be determined if that item was misplaced or the tag is faulty. In an embodiment, an anomaly can be declared after observation of the anomaly in a few consecutive time windows.

In yet another embodiment, a potential or predicate route for the tags moving in, for example, a warehouse. For example, such a route is from a location next to one gateway to a location with another gateway. The routes can be determined based on the affinity propagation. The affinity propagation can be modeled and computed as a function the location matrix of the current time window (Lₜ) and the affinity matrix at the previous time window (Aₜ₋₁).

At S350, a report is sent back to a user terminal. The user terminal may be one of the gateways. The report may include the locations of each tag and any of the generated insights (dynamic grouping of tags in proximity the same location, any anomalies, and routes (mapping)).

The method returns to S310, where packets received during a new time window are processed. The method can continue continuously or as long as new packets are received.

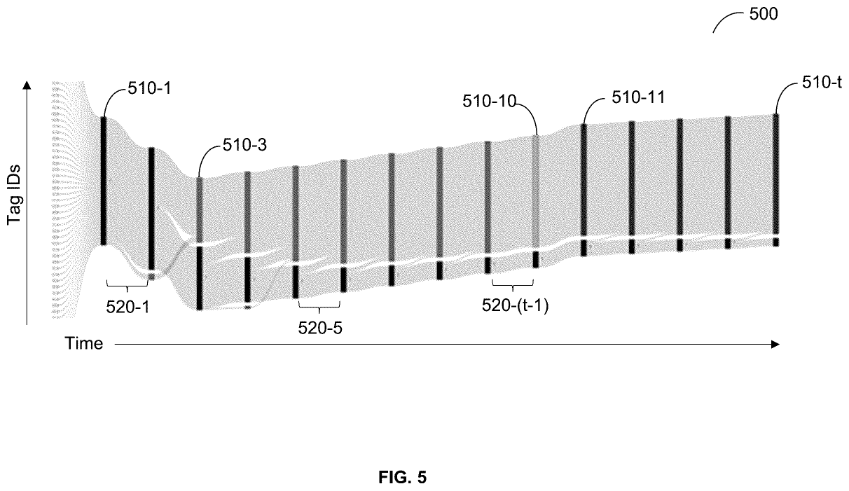

FIG. 5 is an example graph 500 showing tracking of collective locations of a group of IoT tags according to an example embodiment. The example graph is shown as tag IDs vs. time, where time is relative and not explicitly defined. The collective location of the group of IoT tags (i.e., all IoT tags in y-axis) are determined at certain temporal time windows (510-1 through 510-t and collectively 510) with periods of silences (520-1 through 520-(t−1) and collectively 520) between the temporal time windows 510. The change in collective location of the group of IoT tags can be observed at 510-3, 510-10, and 510-11 as indicated by different bars in the temporal time window. In the example, at temporal window 510-1, the location of the group of IoT tags are not yet determined.

In an example embodiment, the location of certain IoT tags may be missing during the temporal window 510. Even in such scenarios, the clustering and collective behavior analysis allow the location of grouped IoT tags to be accurately determined, which may be undetermined when using individual IoT tags for analysis. For example, at temporal window 510-3, locations of a first half of IoT tags are not determined and locations of a second half of the IoT tags are determined. Here, the location for the whole group of IoT tags can be determined based on the location of the second half of the IoT tags through collective analysis, which may not be possible when locations are determined from individual IoT tags. The example graph 500 illustrates continuous monitoring of locations of a group of IoT tags. It should be appreciated that the methods illustrated herein provides journey of items (with IoT tags attached) through time.

It should be noted that the example graph 500 illustrates journey of one group of IoT tags that are kept constant, however, the same IoT tags may be split into multiple groups and/or regrouped with different IoT tags depending on the affinity between the IoT tags as determined in FIG. 3, above. That is, the group of IoT tags may change when a subset of items (including IoT tags) are, for example, removed, moved to another location, combined with other groups of items, and the like.

FIG. 6 is an example schematic diagram of the gateway 120 according to an embodiment. The gateway 120 includes a BLE communication card 650 and a network interface card (NIC) 620. In an embodiment, the BLE communication card 650 communicates with the IoT tag 110 over a BLE network (not shown), while the NIC 620 allows communication with the server 140 over the Internet (not shown), or another type of network.

In an embodiment, the gateway 120 may be installed with an agent or application executed by the processor 670 and stored in the memory 680. The agent, when executed, is configured to control the communication with the IoT tag 110 and the server 140.

It should be noted that the processor 670 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 680 may be volatile (e.g., RAM, etc.), non-volatile (e.g., ROM, flash memory, etc.), or a combination thereof. The agent (or application) is realized in software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processor 670, cause the execution of the agent over the processor 670.

FIG. 7 shows an example schematic diagram of an IoT tag 110, designed according to the disclosed embodiments. The form factor of the IoT tag 110 is an on-die package-less tag. The IoT tag 110, as schematically demonstrated in FIG. 7, includes an energy harvester (harvester) 701, coupled to an on-die capacitor 702 and an external passive capacitor 702′, a power management unit (PMU) 703, a microcontroller 704, a system on chip (SoC) 705, and a retention memory 706. The IoT tag 110 further may include at least one antenna 710 glued to a substrate 720, for example. In another embodiment, the antenna 710 may be printed or etched onto the substrate 720. In a further embodiment, a passive external capacitor may take the place of the antenna 710. In an embodiment, substrate 720 is made of a low-cost material, such as, but not limited to, polyethylene (PET), polyimide (PI), and polystyrene (PS). In another embodiment, the substrate's 720 patterns (layout) can be any of aluminum, copper, or silver. The glue utilized to glue the die and/or antenna 710 may include materials such as an anisotropic conductive film (ACP), any type of conductive glue, solder paste, and the like.

In the embodiment shown in FIG. 7, the antenna 710 is coupled to the harvester 701 and may be utilized for energy harvesting as well as wireless communication. In some embodiments, multiple antennas may be utilized to harvest energy at multiple frequency bands. Other embodiments may include one or more antenna for energy harvesting and an antenna to receive/transmit wireless signals at the BLE frequency band. In some embodiments, the IoT tag includes a printed battery.

The SoC 705 includes a number of execution functions realized as analog circuits, digital circuits, or both. Examples of such execution functions are provided below. The SoC 705 is also configured to carry out processes independently or under the control of the microcontroller 704. Each process carried out by the SoC 705 also has a state, and processes can communicate with other processes through an IPC protocol. In the configuration illustrated in FIG. 7, the SoC 705 and/or the microcontroller 704 loads the context of processes and reads data from the retention memory 706.

The SoC 705 is partitioned into multiple power domains. Each power domain is a collection of gates powered by the same power and ground supply. To reduce the power consumption, only one power domain is turned on during execution. The SoC 705 can perform functions, such as reading from and writing to memory, e.g., of peripherals, and can execute simple logic operations; tracking power level of the SoC 705; generating and preparing data packets for transmission; cyclic redundancy check (CRC) code generation; packet whitening; encrypting/decrypting and authentication of packets; converting data from parallel to serial; and staging the packet bits to the analog transmitter path for transmission.

In a preferred embodiment, the SoC 705 includes an oscillator calibration circuit (OCC) 705-A. The OCC 705-A includes at least one frequency locking circuit (FLC), each of which is coupled to an oscillator (both are not shown). The FLC calibrates the frequency of an oscillator using an over-the-air reference signal. In an embodiment, the calibration of the respective oscillator is performed immediately prior to a data transmission session and remains free running during the data transmission session. The FLC can be realized using frequency locked loop (FLL), a phased locked loop (PLL), and a delay locked loop (DLL). An example implementation of an oscillator calibration circuit 705-A is discussed in U.S. Pat. No. 10,886,929, assigned to the common assignee Yehezkely, and incorporated herein by reference.

According to the disclosed embodiments, the energy harvester 701, the capacitor 702, PMU 703, microcontroller 704, SoC 705, and retention memory 706 are integrated in a die 730. The die 730 is glued to the substrate 720. The IoT tag 110 does not include any external DC power source, such as a battery.

In an embodiment, the microcontroller 704 implements electronic circuits (such as, memory, logic, RF, etc.) performing various functions allowing communication using a low energy (power) communication protocol. Examples for such a protocol includes, but are not limited to, Bluetooth®, LoRa, Wi-Gi®, nRF, DECT®, Zigbee®, Z-Wave, EnOcean, and the like. In a preferred embodiment, the microcontroller 704 operates using a Bluetooth Low Energy (BLE) communication protocol.

In some embodiments, the microcontroller 704 is integrated with wireless sensors (not shown) to complete an IoT device's functionality.

The harvester 701 is configured to provide multiple voltage levels to the microcontroller 704, while maintaining a low loading DC dissipation value. In an example implementation, the energy harvester 701 may include a voltage multiplier coupled to the antenna 710. The voltage multiplier may be a Dickson multiplier, while the antenna 710 is a receive/transmit antenna of the microcontroller 704. That is, in such a configuration, the antenna is primarily designed to receive and/or transmit wireless signals according to the respective communication protocol of the low-energy IoT tag 110 (e.g., 2.400-2.4835 GHz signal for BLE communication).

It should be noted that the antenna 710 may also be designed for energy harvesting and may operate on a different frequency band, direction, or both, than those defined in the standard of the respective communication protocol. Regardless of the configuration, energy can be harvested from any wireless signals received over the air. Alternatively, energy can be harvested from any other sources, such as solar, piezoelectric signals, and the like.

The harvested energy is stored in the on-die capacitor 702 and/or the external capacitor 702′. The PMU 703 is coupled to the capacitor 702 and is configured to regulate the power to the microcontroller 704 and SoC 705. Specifically, as the capacitance of the capacitor 702 is very limited, the power consumption should be carefully maintained. This maintenance is performed to avoid draining of the capacitor 702, thus resetting the microcontroller 704. The PMU 703 can be realized using a Schmitt trigger that operates on a predefined threshold (Vref), e.g., Vref=0.85V.

In another embodiment, the PMU 703 may be further configured to provide multi-level voltage level indications to the microcontroller 704. Such indications allow the microcontroller 704 to determine the state of a voltage supply at any given moment when the capacitor 702 charges or discharges. According to this embodiment, the PMU 703 may include detection circuitry controlled by a controller. The detection circuitry includes different voltage reference threshold detectors, where only a subset of such detectors is active at a given time to perform the detection.

The IoT tag 110 does not include any crystal oscillator providing a reference clock signal. According to an embodiment, the reference clock signal is generated using over-the-air signals received from the antenna 710. As noted above, in a typical deployment, a free-running oscillator is locked via a Phase-Locked Loop (PLL) to a clock, originating from a crystal oscillator. According to the disclosed embodiments, the OCC 705-A calibrates the frequency of an oscillator using an over-the-air reference signal. The oscillator(s) implemented in the tag 730 are on-die oscillators and may be realized as a digitally controlled oscillator (DCO).

The retention memory 706 is a centralized area that is constantly powered. Data to be retained during low power states is located in the retention memory 706. In an embodiment, the retention area is optimized to subthreshold or near threshold voltage, e.g., 0.3V-0.4V. This allows for the reduction of the leakage of the retention cells.

FIG. 8 is an example schematic diagram of a server 140 according to an embodiment. The server 140 includes a processing circuitry 810 coupled to a memory 820, a storage 830, and a network interface 840. In an embodiment, the components of the server 140 may be communicatively connected via a bus 850.

The processing circuitry 810 may be realized as one or more hardware logic components and circuits, examples of which are provided above.

The memory 820 may be volatile (e.g., RAM, etc.), non-volatile (e.g., ROM, flash memory, etc.), or a combination thereof. In one configuration, computer readable instructions to implement one or more embodiments disclosed herein may be stored in the storage 830.

In another embodiment, the memory 820 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 may be magnetic storage, optical storage, and the like, and may be realized, for example, as flash memory or other memory technology, CD-ROM, Digital Versatile Disks (DVDs), or any other medium which can be used to store the desired information.

The network interface 840 allows the server 140 to communicate with the gateways (e.g., gateways 120, FIG. 2) and with the user device (e.g., user device 170, FIG. 1) for the purpose of, for example, receiving data, sending data, and the like. Further, the network interface 840 allows the server 140 to communicate with the IoT tag 110 for the purpose of collecting frequency words.

It should be understood that the embodiments described herein are not limited to the specific architecture illustrated in FIG. 8, and other architectures may be equally used without departing from the scope of the disclosed embodiments.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining locations of internet of things (IoT) tags, comprising:
receiving, during a predefined time window, packets from a plurality of gateways, wherein a received packet includes at least sensing signals transmitted from the IoT tags;
determining an affinity among the IoT tags based on the sensing signals;
determining locations of IoT tags based on the determined affinity and the sensing signals, wherein a location of an IoT tag is a probability that an IoT tag is located in proximity to a gateway; and
reporting the determined locations to a user terminal.

2. The method of claim 1, further comprising clustering IoT tags based on their determined locations.

3. The method of claim 1, wherein receiving, during a predefined time window, packets from a plurality of gateways, further comprises:
for each of the IoT tags, creating a vector of an average value of sensing signals transmitted by each of the IoT tags as received by each of the gateways; and
forming a sensing signal matrix based on the created vectors.

4. The method of claim 3, wherein determining the affinity among the IoT tags based on the sensing signals further comprises:
for each pair of IoT tags, computing a distance metric between the pair of IoT tags, wherein the distance metric is computed using the respective average values of sensing signals included in the sensing signal matrix; and
forming an affinity matrix based on the distance metric.

5. The method of claim 4, computing the distance metric using any one of: a Euclidean distance function, and a cosine similarity.

6. The method of claim 5, wherein determining locations of IoT tags further comprises:
applying a probabilistic graphical model to estimate a location matrix of a current time window, wherein the probabilistic graphical model is applied on the affinity matrix determined for a pervious time window, the sensing signal matrix of the current time window, and a location matrix of a pervious time window, wherein the location matrix includes probabilities of each IoT tag located in a proximity to each of the gateways.

7. The method of claim 6, wherein probabilistic graphical model is a dynamic Bayesian network (DBN).

8. The method of claim 1, wherein an IoT tag is a wireless battery-less IoT tag communicating with a gateway using a low-power communication protocol.

9. The method of claim 1, wherein the method is performed by a server, wherein each of the gateways communicate with the server over the Internet.

10. The method of claim 1, wherein a packet includes sensing signals transmitted by an IoT tag, an identifier of the IoT tag transmitting the sensing signals, and an identifier of the gateway.

11. The method of claim 1, wherein a sensing signal includes any one of: a frequency word, a received signal strength indicator (RSSI), a digitally controlled oscillator (DCO) signal.

12. A non-transitory computer readable medium having stored thereon instructions for causing a processing circuitry to execute a process, the process comprising:
method for locations of internet of things (IoT) tags, comprising:
receiving, during a predefined time window, packets from a plurality of gateways, wherein a received packet includes at least sensing signals transmitted from the IoT tags;
determining an affinity among the IoT tags based on the sensing signals;
determining locations of IoT tags based on the determined affinity and the sensing signals, wherein a location of an IoT tag is a probability that an IoT tag is located in a proximity to a gateway; and
reporting the determined locations to a user terminal.

13. A system for determining locations of internet of things (IoT) tags, comprising:
a processing circuitry;
a memory connected to the processing circuitry and configured to contain a plurality of instructions that when executed by the processing circuitry configure the system to:
receive, during a predefined time window, packets from a plurality of gateways, wherein a received packets include at least sensing signals transmitted from the IoT tags;
determine an affinity among the IoT tags based on the sensing signals;
determine locations of IoT tags based on the determined affinity and the sensing signals, wherein a location of an IoT tag is a probability that an IoT tag is located in proximity to a gateway; and
report the determined locations to a user terminal.

14. The system of claim 13, wherein the system is further configured to:
cluster IoT tags based on their determined locations.

15. The system of claim 13, wherein the system is further configured to:
for each of the IoT tags, create a vector of an average value of sensing signals transmitted by each of the IoT tags as received by each of the gateways; and
form a sensing signal matrix based on the created vectors.

16. The system of claim 15, wherein the system is further configured to:
for each pair of IoT tags, compute a distance metric between the pair of IoT tags, wherein the distance metric is computed using the respective average values of sensing signals included in the sensing signal matrix; and
form an affinity matrix based on the distance metric.

17. The system of claim 16, computing the distance metric using any one of: a Euclidean distance function, and a cosine similarity.

18. The system of claim 17, wherein the system is further configured to:
apply a probabilistic graphical model to estimate a location matrix of a current time window, wherein the probabilistic graphical model is applied on the affinity matrix determined for a pervious time window, the sensing signal matrix of the current time window, and a location matrix of a pervious time window, wherein the location matrix includes probabilities of each IoT tag located in a proximity to each of the gateways.

19. The system of claim 18, wherein the probabilistic graphical model is a dynamic Bayesian network (DBN).

20. The system of claim 13, wherein an IoT tag is a wireless battery-less IoT tag communicating with a gateway using a low-power communication protocol.

21. The system of claim 13, wherein a packet includes sensing signals transmitted by an IoT tag, an identifier of the IoT tag transmitting the sensing signals, and an identifier of the gateway.

22. The system of claim 13, wherein a sensing signal includes any one of: a frequency word, a received signal strength indicator (RSSI), a digitally controlled oscillator (DCO) signal.
